(19) United States
(12) Patent Application Publication
(10) Pub. No.: US 2013/0185676 A1
(43) Pub. Date: Jul. 18, 2013

(54) METHOD AND MOBILE DEVICE FOR CLASSIFIED WEBPAGE SWITCHING

(71) Applicant: Alibaba Group Holding Limited, George Town (KY)

(72) Inventor: Sha Cao, Hangzhou (CN)

(73) Assignee: ALIBABA GROUP HOLDING LIMITED, George Town (KY)

(21) Appl. No.: 13/741,971

(22) Filed: Jan. 15, 2013

(30) Foreign Application Priority Data
Jan. 18, 2012 (CN) 201210016753.2

(51) Int. Cl. G06F 3/0482

(52) U.S. Cl. CPC G06F 3/0482
USPC 715/833

(57) ABSTRACT

Embodiments of the present application relate to a classified webpage switching method, a mobile device for classified webpage switching, and a computer program product for classified webpage switching. A classified webpage switching method is provided. The method includes receiving, via a touch-sensitive screen, information pertaining to a sliding action performed by a user, determining whether the sliding action is a designated sliding action, displaying a classification options zone containing a plurality of classification labels in the event that the sliding action is the designated sliding action, selecting a classification label from among the plurality of classification labels based on the designated sliding action, sequentially changing the classification label that is selected from among the plurality of classification labels, and switching the current classified webpage to a classified webpage corresponding to the currently selected classification label in the event that contact with the display screen has stopped.

### CROSS REFERENCE TO OTHER APPLICATIONS

This application claims priority to People's Republic of China Patent Application No. 201210016753.2 entitled A METHOD AND MOBILE EQUIPMENT FOR CLASSIFIED PAGE SWITCHING, filed Jan. 18, 2012 which is incorporated herein by reference for all purposes.

### FIELD OF THE INVENTION

The present application relates to a method and mobile device for classified webpage switching.

### BACKGROUND OF THE INVENTION

With the development of wireless communications technology, users are provided with greater network bandwidth and faster data transmission. Correspondingly, users can be provided with a greater array of network services. Mobile devices accordingly can provide more functions in order to support the services provided by wireless communications providers and provide the users with better wireless service experiences. For example, the users can perform actions, such as tapping and sliding, on a mobile device having touchscreens to control the mobile device.

As display screens of the mobile devices have increased in size and hardware performance of the mobile devices have improved, Internet services once reserved for personal computers have, in the past few years, gradually been implemented onto mobile devices. For example, users can browse content-rich webpages on their mobile device.

However, the screen size of display screens of current mobile devices is still relatively small for content-rich webpages. The display screens of the mobile devices often cannot fully display every type of content included in the content-rich webpages. For example, the webpages can include some required control zones when the users are browsing the webpages. In order to display as much of the main content of the webpage as possible within the limited display screen of the mobile device, the mobile device generally hides the control zones. When a user needs to access the control zones, the user can trigger a display of the control zones by touching the display screen and then control the webpage by next touching the control zone.

For example, in a product information webpage, when a user browses the product information webpage, the user may want to review the browsed product information. Generally, the product information webpage includes a classification options zone for screening the product information. When a product information webpage is displayed to the user, the classification options zone will be hidden. If the user wants to view the product information via the classification options zone, i.e., switch between classified webpages corresponding to various types of products, the user typically performs the following steps:

First, the user taps a designated position on the display screen of the mobile device, and the mobile device, based on the tapping action, triggers the display of a webpage containing the classification options zone.

Next, the user, while viewing the classification labels included in the classification options zone, taps a desired classification label to select the classification label. The mobile device, based on this second tapping action, triggers the display of a classified webpage corresponding to the selected classification label.

In the above-described method for switching classified webpages, the user performs multiple actions vis-à-vis the display screen. The mobile device accordingly generates a webpage corresponding to each user action and displays the corresponding webpage to the user so that the user can perform a further action based on the webpage displayed. Thus, switching between classified webpages is accomplished through multiple interactions between the user and the mobile device.

Accordingly, reducing the amount of interactions for switching between classified webpages would improve efficiency and reduce energy consumption of the mobile device.

### BRIEF DESCRIPTION OF THE DRAWINGS

Various embodiments of the invention are disclosed in the following detailed description and the accompanying drawings.

FIG. 1A is a functional diagram illustrating a programmed computer system for displaying classified webpages in accordance with some embodiments.

FIG. 1B is a flow chart illustrating an embodiment of a classified webpage switching method.

FIG. 2 is a flow chart illustrating another embodiment of a classified webpage switching method.

FIG. 3 is a diagram illustrating an embodiment of a user performing a sliding action on a current webpage.

FIG. 4 is a diagram illustrating an embodiment of a classification options zone triggered for display at the top of a display screen.

FIG. 5 is a diagram illustrating an embodiment of the user completing the sliding action when a currently selected classification label is classification label B.

FIG. 6 is a diagram illustrating an embodiment of a classified webpage displaying classification B after the user has completed the sliding action.

FIG. 7 is a diagram illustrating an embodiment of the classification options zone simultaneously displaying more than two classification labels.

FIG. 8 is a diagram illustrating an embodiment of a plurality of classification labels included in the classification options zone being displayed in disc form.

FIG. 9 is a structural diagram illustrating an embodiment of a classified webpage switching mobile device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The following disclosure discloses a method and a mobile device for classified webpage switching. The method allows users to switch between classified webpages displayed on display screens of mobile devices.

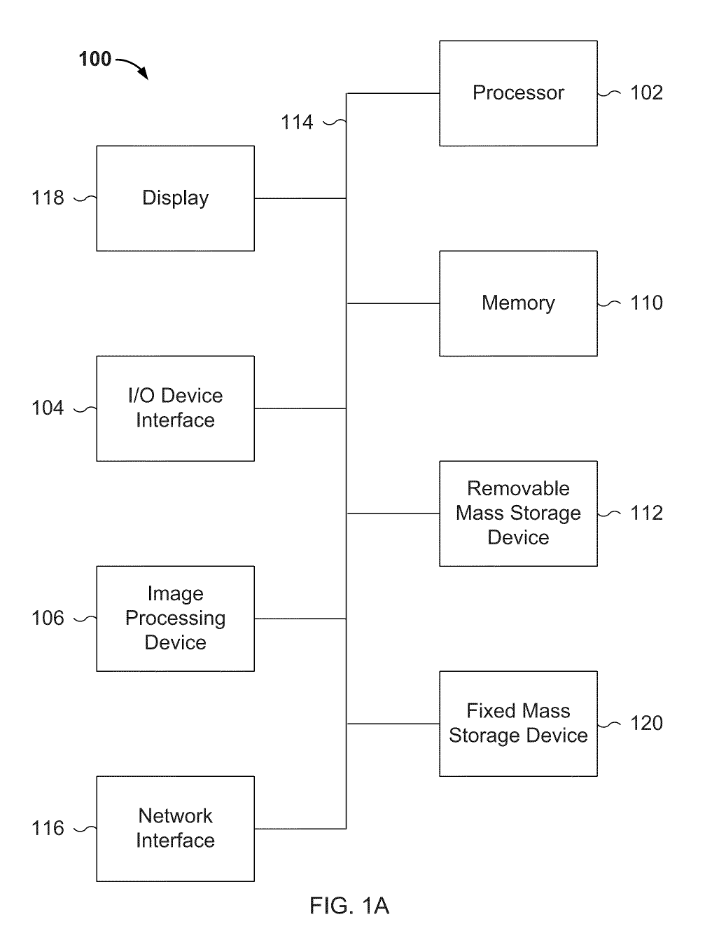

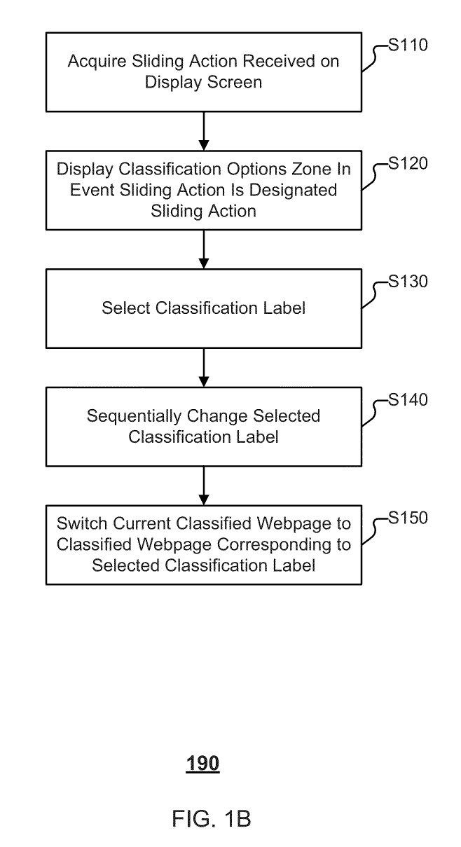

FIG. 1A is a functional diagram illustrating a programmed computer system for displaying classified webpages in accordance with some embodiments. As will be apparent, other computer system architectures and configurations can be used to perform the described classified webpage displaying technique. Computer system 100, which includes various subsystems as described below, includes at least one microprocessor subsystem (also referred to as a processor or a central processing unit (CPU) 102). For example, processor 102 can be implemented by a single-chip processor or by multiple processors. In some embodiments, processor 102 is a general purpose digital processor that controls the operation of the computer system 100. In some embodiments, processor 102 also includes one or more coprocessors or special purpose processors (e.g., a graphics processor, a network processor, etc.). Using instructions retrieved from memory 110, processor 102 controls the reception and manipulation of input data received on an input device (e.g., image processing device 106, I/O device interface 104), and the output and display of data on output devices (e.g., display 118).

Processor 102 is coupled bi-directionally with memory 110, which can include, for example, one or more random access memories (RAM) and/or one or more read-only memories (ROM). As is well known in the art, memory 110 can be used as a general storage area, a temporary (e.g., scratch pad) memory, and/or a cache memory. Memory 110 can also be used to store input data and processed data, as well as to store programming instructions and data, in the form of data objects and text objects, in addition to other data and instructions for processes operating on processor 102. Also as is well known in the art, memory 110 typically includes basic operating instructions, program code, data, and objects used by the processor 102 to perform its functions (e.g., programmed instructions). For example, memory 110 can include any suitable computer readable storage media described below, depending on whether, for example, data access needs to be bi-directional or uni-directional. For example, processor 102 can also directly and very rapidly retrieve and store frequently needed data in a cache memory included in memory 110.

A removable mass storage device 112 provides additional data storage capacity for the computer system 100, and is optionally coupled either bi-directionally (read/write) or uni-directionally (read only) to processor 102. A fixed mass storage 120 can also, for example, provide additional data storage capacity. For example, storage devices 112 and/or 120 can include computer readable media such as magnetic tape, flash memory, PC-CARDS, portable mass storage devices such as hard drives (e.g., magnetic, optical, or solid state drives), holographic storage devices, and other storage devices. Mass storages 112 and/or 120 generally store additional programming instructions, data, and the like that typically are not in active use by the processor 102. It will be appreciated that the information retained within mass storages 112 and 120 can be incorporated, if needed, in standard fashion as part of memory 110 (e.g., RAM) as virtual memory.

In addition to providing processor 102 access to storage subsystems, bus 114 can be used to provide access to other subsystems and devices as well. As shown, these can include a display 118, a network interface 116, an input/output (I/O) device interface 104, an image processing device 106, as well as other subsystems and devices. For example, image processing device 106 can include a camera, a scanner, etc.; I/O device interface 104 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 100. Multiple I/O device interfaces can be used in conjunction with computer system 100. The I/O device interface can include general and customized interfaces that allow the processor 102 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 116 allows processor 102 to be coupled to another computer, computer network, or telecommunications network using a network connection as shown. For example, through the network interface 116, the processor 102 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

In addition, various embodiments disclosed herein further relate to computer storage products with a computer readable medium that includes program code for performing various computer-implemented operations. The computer readable medium includes any data storage device that can store data which can thereafter be read by a computer system. Examples of computer readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system shown in FIG. 1A is but an example of a computer system suitable for use with the various embodiments disclosed herein. Other computer systems suitable for such use can include additional or fewer subsystems. In some computer systems, subsystems can share components (e.g., for touchscreen-based devices such as smart phones, tablets, etc., I/O device interface 104 and display 118 share the touch sensitive screen component, which both detects user inputs and displays outputs to the user). In addition, bus 114 is illustrative of any interconnection scheme serving to link the subsystems. Other computer architectures having different configurations of subsystems can also be utilized.

FIG. 1B is a flow chart illustrating an embodiment of a classified webpage switching method. The method 190 includes the following steps:

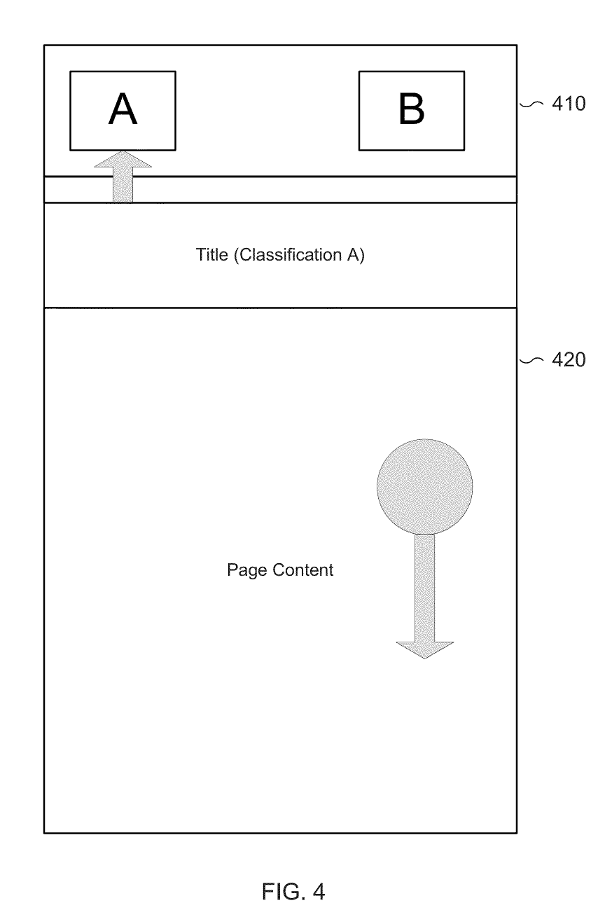

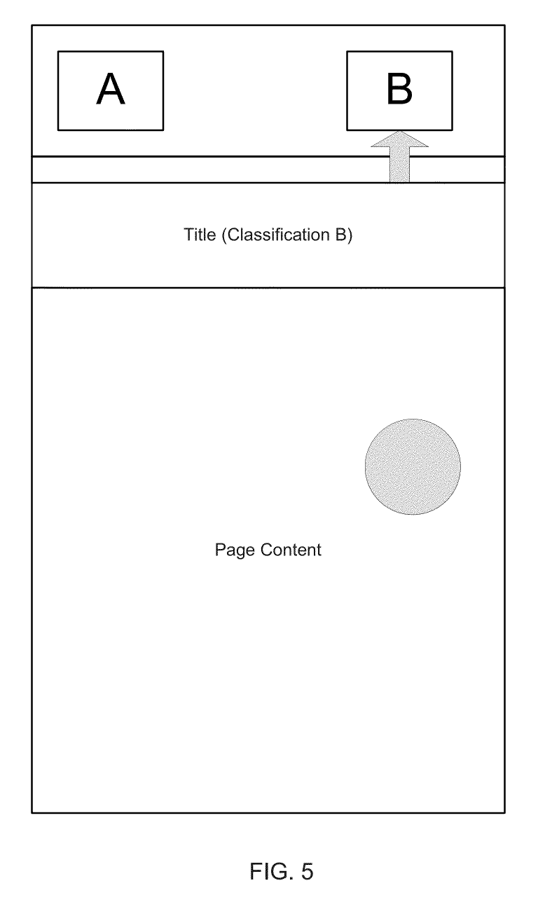

In step S110, a mobile device detects a sliding action on a screen of the mobile device. During the sliding action, the user maintains contact with the touch-sensitive display screen. For example, the user can keep one or more fingers on the touchscreen and move the finger around. In step S120, the screen of the mobile device displays a classification options zone. The classification options zone includes a plurality of classification labels in the event that the sliding action is a designated sliding action. Referring to FIGS. 4 and 5 (to be discussed later in more detail), classification A is switched to classification B based on a sliding action. Classifications A and B represent classification labels, and the classification labels are located in the classification options zone. A sliding action can be down, up, left, right, circular, triangular, letters, shapes, etc., to signal the switching of the classifications. A designated sliding action can correspond to the specific sliding action. The designated sliding action can be configured by the user. The sliding action takes place in a region that's separate from the classification zone. In response to the sliding action, the selected classification switches from classification A to classification B. The user is therefore not required to directly select classification B using the classification label. In FIG. 4, a down sliding action is illustrated to be discussed later.

While the user continues with the sliding action (e.g., while the user's finger continues to swipe across the screen), at S130, the device in response continuously changes which classification label is being selected and displays the currently selected classification label, at S140. When the user completes the sliding action (e.g., when his finger leaves the screen), at S150, the mobile device switches the current classified webpage to a classified webpage corresponding to the currently selected classification label.

The method and mobile device provided by the present application are described below.

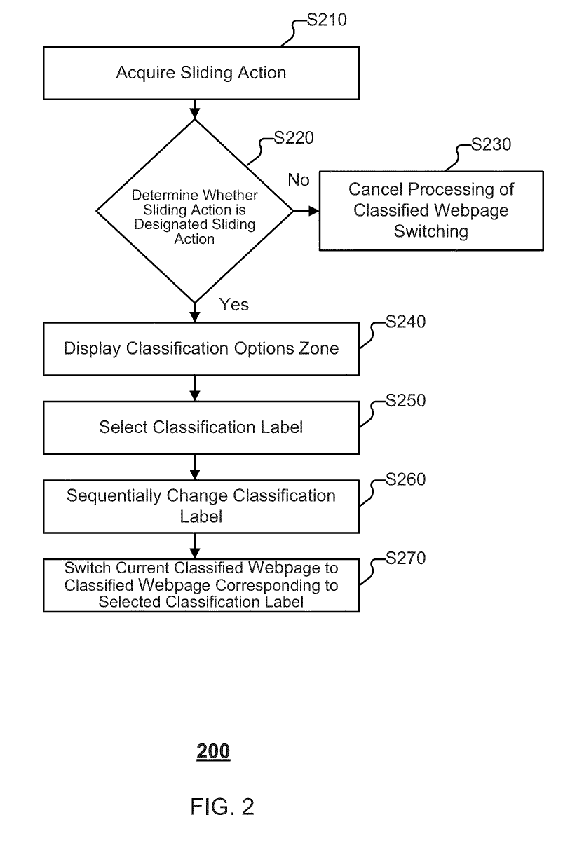

FIG. 2 is a flow chart illustrating another embodiment of a classified webpage switching method. The method 200 includes the steps below:

A user can perform a sliding action on the current webpage on a display screen of a mobile device. The sliding action can also be described as a gesture vis-à-vis the display screen and includes contact with the display screen.

In some embodiments, the current webpage can be a classified webpage relating to one classification among a plurality of classified webpages. An example of classifications can include Web Images Video, Local, and News found on a webpage such as Yahoo's home page (www.yahoo.com). In some embodiments, the current webpage can be a global webpage not yet classified instead of being a classified webpage. For example, the global webpage can be a website's home page such as www.yahoo.com.

In step S210, the mobile device is configured to detect a sliding action received on the display screen of the mobile device. The detection of the sliding action can be detected by various well known methods (e.g., according to application programming interfaces (APIs) supported by the operating system of the mobile device).

In step S220, the mobile device is configured to determine whether the detected sliding action is a designated sliding action. In the event that the detected sliding action is not the designated sliding action, then step S230 is performed. In the event that the detected sliding action is the designated sliding action, then step S240 is performed.

In step S220, the designated sliding action is preset. For example, the designated sliding action can be preset based on operating habits of a current user vis-à-vis a mobile device having a touchscreen. The designated sliding action can be set as a downward sliding action or a downward swipe, or the designated sliding action be set as a rightward sliding action or a rightward swipe. The downward sliding action can be a gesture corresponding to a pull-down gesture or a scrolling down action. The rightward sliding action can be a gesture corresponding to a push-aside gesture or a scrolling to the right action.

Furthermore, a plurality of designated sliding actions may be set as the designated sliding action. For example, the plurality of designated sliding actions can be set to include the downward sliding action and the rightward sliding action.

In addition, the designated sliding action can also be set to correspond to the current display format of the display screen of the mobile device. For example, if the current display format of the display screen is a vertical screen display, the designated sliding action can be set to a downward sliding action. If the current display format is a horizontal screen display, the designated sliding action can be set to the rightward sliding action or a leftward sliding action.

In step S230, in the event that the mobile device determines that the sliding action does not correspond with the preset designated sliding action, the mobile device can determine that the detected screen action was not intended to execute an action of switching a classified webpage. Thus, the mobile device is configured to cancel the processing of the classified webpage switching.

Furthermore, in this step, the mobile device triggers additional actions based on the meaning represented by the sliding action. Further details of the additional actions will be provided below.

In step S240, in the event that the sliding action is determined to correspond with the preset designated sliding action, the mobile device is configured to display a classification options zone containing a plurality of classification labels on the display screen.

In another example, the displaying of the classification options zone may be based on characteristics of the preset designated sliding action. The displaying of the classification options zone can be related to the operating habits of the users. For example, the displaying of the classification options zone can be any combination of the following actions:

The displaying of the classification options zone containing a plurality of classification labels can be at the top of the display screen when the sliding action is a downward sliding action;

The displaying of the classification options zone containing a plurality of classification labels can be at the bottom of the display screen when the sliding action is an upward sliding action;

The displaying of the classification options zone containing a plurality of classification labels can be at the left side of the display screen when the sliding action is a rightward sliding action; and

The displaying of the classification options zone containing a plurality of classification labels can be at the right side of the display screen when the sliding action is a leftward sliding action.

For example, when users use a mobile terminal, the users can grip the mobile terminal across its width and browse contents of the display screen lengthwise from top to bottom. Accordingly, the mobile device can be customized to display the classification options zone at the top of the display screen when the user performs a downward sliding action.

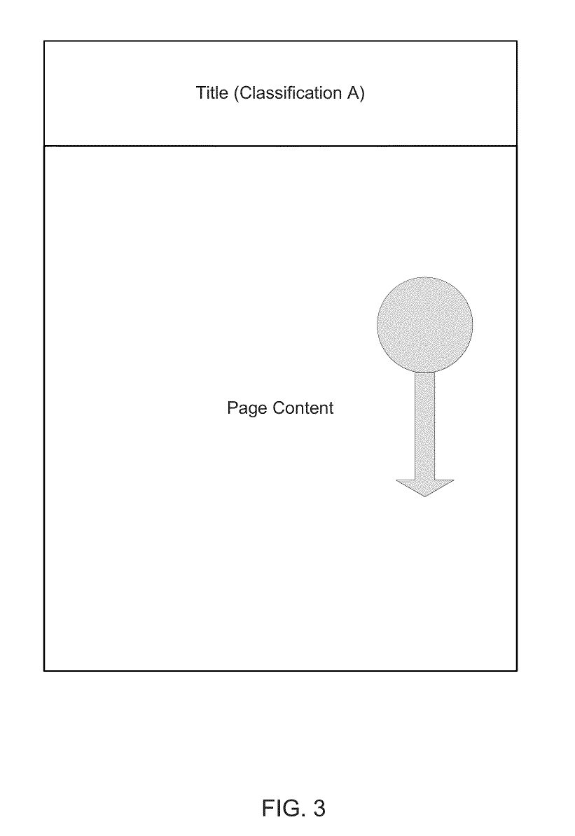

Examples of various sliding actions are illustrated in FIGS. 3 and 4. FIG. 3 is a diagram illustrating an embodiment of a user performing a sliding action on a current webpage. FIG. 4 is a diagram illustrating an embodiment of a classification options zone triggered for display at the top of the display screen. In FIG. 3, assume that the current webpage is a classified webpage corresponding to classification A, and as an example, the classification options zone is triggered by a downward sliding action. In the current webpage shown, the user executes a downward sliding action on the display screen. The mobile device, as a result of the downward sliding action, displays a classification options zone at the top of the display screen, as shown in FIG. 4. The classification options zone includes classification labels for classification A and classification B. One example of the classifications A and B can include Web, Images, Video, Local, News, etc. Another example of the classifications A and B can include Movies, Music, Games, etc. Many different classification options can be used.

In step S250, after the classification options zone containing a plurality of classification labels is displayed, the mobile device is configured to select a classification label. In some embodiments, the classification label can be selected based on the sliding action that takes place in a separate region. In step S260, while the sliding action is in progress, the mobile device is configured to sequentially change the classification label selected from among the plurality of classification labels based on the current location of the user's finger during the sliding action. For example, as shown in FIG. 4, the classification label corresponding to classification A is selected and changed. The arrow pointing at the classification label corresponding to classification A indicates that the classification label corresponding to classification A has been selected.

In some embodiments, when the sliding action is the designated sliding action, the mobile device assumes that the user intends that the designated sliding action select a classification label and the user does not intend a different action, such as a page scrolling action.

In some embodiments, the triggering method for selecting the classification label is based on a preset direction and speed. In some embodiments, the triggering method is based on an action subsequent to the user's present sliding action.

In a first embodiment of a triggering method, after the displaying of the classification options zone containing the plurality of classification labels, the mobile device sequentially changes the classification label that is selected from the classification options zone which was triggered for display in accordance with a set speed and a set direction. For example, depending on the user's operating habits, the set direction can be from left to right or from right to left. In another example, the set direction can be from top to bottom or from bottom to top.

In a second embodiment of a triggering method, the user performs a sliding action on the display screen. For example, after the classification options zone is triggered for display, the user maintains contact with the display screen and then performs a subsequent sliding action to control the direction of the sequential change of the selected classification label. The mobile device accordingly determines the current sliding direction of the subsequent sliding action. The classification label that is selected is changed in the direction corresponding to the current determined sliding direction of the subsequent sliding action. For example, in the event that the current sliding direction is rightward, the order of the change is from left to right. In the event that the specific current sliding direction is leftward, the order of the change is from right to left. In the event that the specific current sliding direction is downward, the order of the change is from top to bottom. In the event that the specific current sliding direction is upward, the order of the change is from bottom to top. In the above example, the order of the change of the selected classification label can correspond with a set direction.

In a third embodiment of a triggering method, after the user performs the sliding action on the display screen that triggers the display of the classification options zone 410, the user maintains contact with the display screen and then uses the speed of a subsequent sliding action to control the speed of the change of the selected classification label. The mobile device accordingly determines the current sliding speed of the subsequent sliding action and the current classification label that is selected changes at a speed corresponding to the current sliding speed of the subsequent sliding action. The greater the current sliding speed is, the greater the speed of the corresponding sequential change will be. As shown in FIG. 4, the subsequent sliding action can be another top to bottom sliding action that takes place in page content region 420, and the speed of change or switching speed of categories A, B, etc. can be based on the speed of the sliding action. In this case, the speed of change to the currently selected classification label can correspond with a preset speed.

In a fourth embodiment of a triggering method, after the user performs the sliding action on the display screen that triggers the display of the classification options zone, the user maintains contact with the display screen and then uses the direction of a subsequent sliding action to control sequential change of the selected classification label and uses the speed of a subsequent sliding action to control the speed of the sequential change of the selected classification label. The mobile device accordingly determines the current sliding speed and the current sliding direction of the sliding action, and the classification label which is triggered for selection undergoes a sequential change at a speed corresponding to the current sliding speed of the sliding action and in a direction corresponding to the current sliding direction of the sliding action. The second and third triggering methods described above can be referenced for the specific speed and change direction.

In the sequentially changing of the selected classification label from among the plurality of classification labels in step S260, the mobile device determines that the sliding action of the user has ended on the mobile device based on the selection of the classification label. In other words, the user ends contact with the display screen of the mobile device. For example, the current sliding action ends when the currently selected classification label is the classification label corresponding to the classified webpage that the user wishes to browse.

FIG. 5 is a diagram illustrating an embodiment of the user completing the sliding action when a currently selected classification label is classification label B. For example, as shown in FIG. 5, the user ends the current sliding action when the currently selected classification label is classification B.

In step S270, when the mobile device detects that contact with the display screen of the mobile device has ceased, the mobile device is configured to switch the current classified webpage to a classified webpage corresponding to the currently selected classification label.

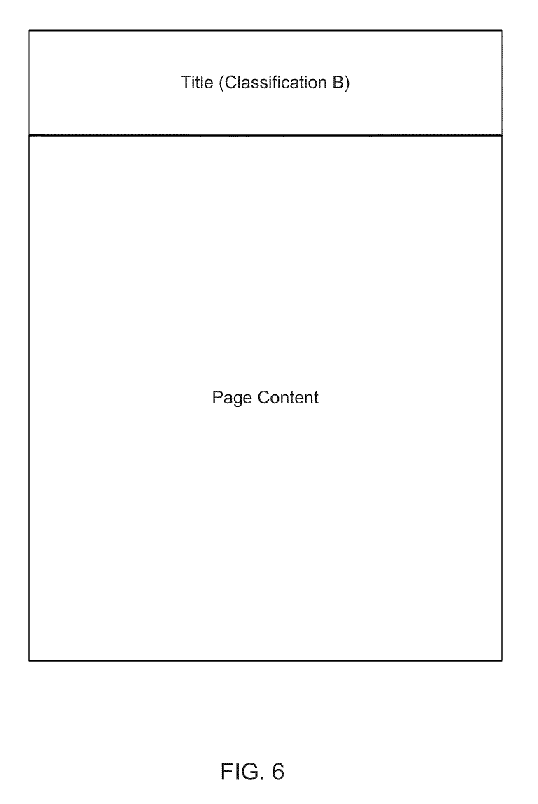

FIG. 6 is a diagram illustrating an embodiment of a classified webpage displaying classification B after the user has completed the sliding action. For example, as shown in FIG. 6, when the user ends the sliding action where a currently selected classification label is the classification label for classification B, the classified webpage for classification B is displayed.

In the webpage display diagrams shown in FIGS. 3 through 6, two classification labels are currently displayed in the classification options zone. Also, the display format of the two classification labels is horizontal.

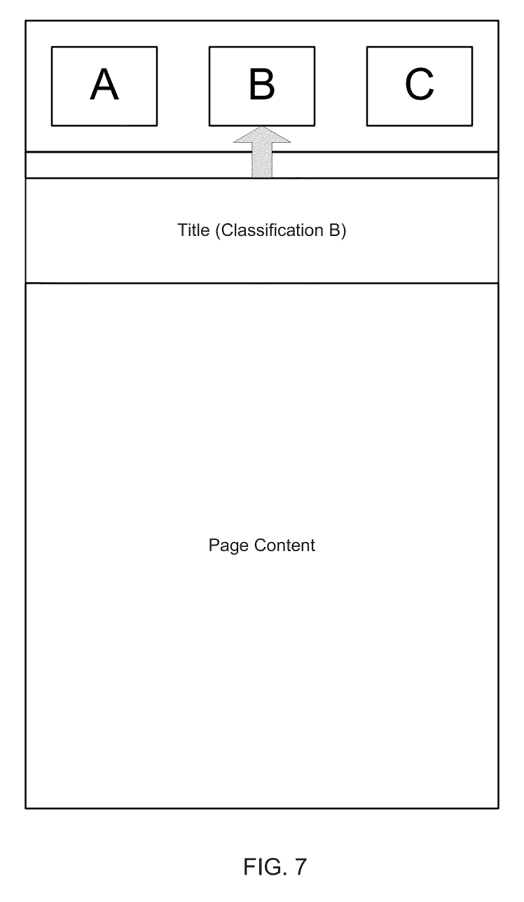

FIG. 7 is a diagram illustrating an embodiment of the classification options zone simultaneously displaying more than two classification labels. In some embodiments, as shown in FIG. 7, more than two classification labels can be simultaneously displayed on the display screen. In addition, there is no preset display format.

The selecting of a classification label may take place when a set of predefined conditions are met. For example, the predefined conditions can include that the mobile device displays a classification options zone 410 and the sliding action is a designated sliding action. In another example, the predefined conditions can include that the mobile device does not display a classification options zone 410 and the sliding action is a designated sliding action, and in the event that the predefined conditions are satisfied, the mobile device displays a classification options zone 410. In the above example, after the predefined conditions are satisfied, the mobile device displays the classification options zone, the sliding action is the designated sliding action, and the selected classification labels A, B, and C are sequentially selected. In other words, as the designated sliding action proceeds, the selected classification label switches from classification label A to classification label B to classification label C. The switching can be determined based on a predetermined distance or a length of time of the designated sliding action.

In some embodiments, the designated sliding action sequentially changes the selected classification label from classification label A to classification label B to classification label C to classification label A. In some embodiments, the designated sliding action sequentially changes the selected classification label from classification label C to classification label B to classification label A to classification label C.

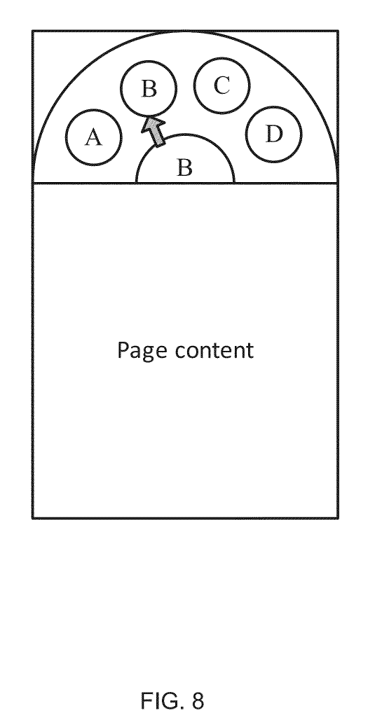

FIG. 8 is a diagram illustrating an embodiment of a plurality of classification labels included in the classification options zone being displayed in disc form. For example, as shown in FIG. 8, a plurality of classification labels can be displayed in the form of a disc.

By employing the above process described in steps S210 through S270, the user needs to touch the display screen only once, and the mobile device can accordingly complete the classified webpage switch on the basis of the single touch action of the user. Therefore, the process provides a more efficient switching method between classified webpages than conventional switching methods, which entails multiple interactions between the user and the mobile device.

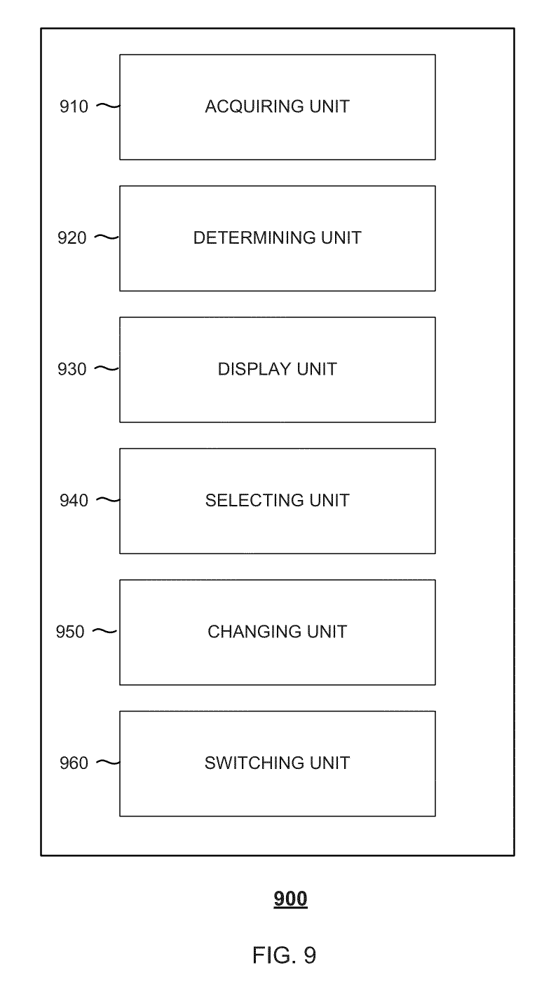

FIG. 9 is a structural diagram illustrating an embodiment of a classified webpage switching mobile device. The classified webpage switching methods 190 and 200 can be implemented by the mobile device 900. The mobile device 900 includes an acquiring unit 910, a determining unit 920, a display unit 930, a selecting unit 940, a changing unit 950, and a switching unit 960.

The acquiring unit 910 is configured to acquire a sliding action received on the display screen or display unit 930 of the mobile device.

The determining unit 920 is configure to determine whether the received sliding action is a designated sliding action.

The display unit 930 is configured to display a classification options zone having a plurality of classification labels in the event that the received sliding action is the designated sliding action. In some embodiments, in the event that the received sliding action is not the designated sliding action, the display unit 930 can cancel the processing of the classified webpage switching.

The selecting unit 940 is configured to select a classification label that is selected from the plurality of classification labels. In some embodiments, the classification label can be selected based on the sliding action. In some embodiments, the classification label can be selected via a user click.

The changing unit 950 is configured to sequentially change the selected classification label based on the received sliding action. In other words, while the user continues with the sliding action (e.g., while the user's finger continues to swipe across the screen), the changing unit 950, in response, continuously changes which classification label is being selected and displays the currently selected classification label.

The switching unit 960 is configured to switch the current classified webpage to the classified webpage corresponding to the currently selected classification label in the event that contact of the received sliding action with the display screen has stopped. In other words, when the user completes the sliding action (e.g., when his finger leaves the screen), the switching unit 960 switches the current classified webpage to a classified webpage corresponding to the currently selected classification label.

In some embodiments, the display unit 930 is configured to display the classification options zone containing the plurality of classification labels at the top of the display screen in the event that the sliding action is a downward sliding action.

In some embodiments, the display unit 930 is configured to display the classification options zone containing the plurality of classification labels at the bottom of the display screen in the event that the sliding action is an upward sliding action.

In some embodiments, the display unit 930 is configured to display the classification options zone containing the plurality of classification labels on the left side of the display screen in the event that the sliding action is a rightward sliding action.

In some embodiments, the display unit 930 is configured to display the classification options zone containing the plurality of classification labels on the right side of the display screen in the event that the sliding action is a leftward sliding action.

In some embodiments, the changing unit 950 is configured to sequentially change the classification label that is selected from the classification options zone which was triggered for display in accordance with a set speed and a set sequence.

In some embodiments, the acquiring unit 910 is configured to determine the current sliding direction of the sliding action after the display unit 930 displays the classification options zone containing the plurality of classification labels.

In some embodiments, the display unit 930 is configured to sequentially change the classification label that is selected from the classification options zone which was triggered for display in accordance with the direction corresponding to the current sliding direction of the sliding action.

In some embodiments, the acquiring unit 910 is configured to determine the current sliding speed of the sliding action after the display unit 930 displays the classification options zone containing the plurality of classification labels.

In some embodiments, the display unit 930 is configured to sequentially change the classification label that is selected from the classification options zone which was triggered for display in accordance with the speed corresponding to the current sliding speed of the sliding action and the direction corresponding to the current sliding direction of the sliding action.

The functions of each of the units described above may correspond to the appropriate processing step in the processes described in FIGS. 1B and 2. Thus, a further explanation of the units are omitted for conciseness.

In some embodiments, the mobile device is configured to acquire a sliding action received on a display screen of the mobile device, determine whether the sliding action is a designated sliding action, display a classification options zone containing a plurality of classification labels in the event that the sliding action is the designated sliding action, select a classification label from among the plurality of classification labels, sequentially change the selected classification label, and switch the current classified webpage to the classified webpage corresponding to the currently selected classification label in the event that contact with the display screen has stopped. The above process improves the efficiency of switching between classified webpages.

The units described above can be implemented as software components executing on one or more general purpose processors, as hardware such as programmable logic devices and/or Application Specific Integrated Circuits designed to perform certain functions, or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A classified webpage switching method, comprising:
receiving, via a touch-sensitive display screen, information pertaining to a sliding action performed by a user;
determining whether the sliding action is a designated sliding action;
displaying a classification options zone containing a plurality of classification labels in the event that the sliding action is the designated sliding action;
selecting a classification label from among the plurality of classification labels;
sequentially changing the classification label that is selected from among the plurality of classification labels based on the sliding action; and
switching a current classified webpage to a classified webpage corresponding to the selected classification label in the event that contact of the sliding action with the touch-sensitive display screen has stopped.

2. The method as described in claim 1, wherein the displaying of the classification options is zone containing the plurality of classification labels, in the event that the sliding action is the designated sliding action, comprises:
displaying the classification options zone containing the plurality of classification labels at the top of the touch-sensitive display screen in the event that the sliding action is a downward sliding action.

3. The method as described in claim 1, wherein the displaying of the classification options zone containing the plurality of classification labels, in the event that the sliding action is the designated sliding action, comprises one of the following steps:
displaying the classification options zone containing the plurality of classification labels at the bottom of the touch-sensitive display screen in the event that the sliding action is an upward sliding action;
displaying the classification options zone containing the plurality of classification labels on the left side of the touch-sensitive display screen in the event that the sliding action is a rightward sliding action; and
displaying the classification options zone containing the plurality of classification labels on the right side of the touch-sensitive display screen in the event that the sliding action is a leftward sliding action.

4. The method as described in claim 1, wherein the displaying of the classification options zone containing the plurality of classification labels, in the event that the sliding action is the designated sliding action, comprises:
the classification label that is selected from the classification options zone which was triggered for display undergoes sequential change in accordance with a set speed and a set direction.

5. The method as described in claim 1, wherein the displaying of the classification options zone containing the plurality of classification labels, in the event that the sliding action is the designated sliding action further, comprises:
determining a current sliding direction of the sliding action,
wherein the sequentially changing of the classification label that is selected from among the plurality of classification labels occurs in accordance to a direction corresponding to the current sliding direction of the sliding action.

6. The method as described in claim 5, wherein the displaying of the classification options zone containing the plurality of classification labels, in the event that the sliding action is the designated sliding action, further comprises:
determining a current sliding speed of the sliding action,
wherein the sequentially changing of the classification label that is selected from among the plurality of classification labels occurs in accordance with a speed corresponding to the current sliding speed of the sliding action and the direction corresponding to the current sliding direction of the sliding action.

7. The method as described in claim 1, wherein the sliding action occurs in a region on the touch-sensitive display screen different from the classification options zone.

8. A mobile device for classified webpage switching, comprising:
a touch-sensitive display screen;
at least one processor configured to:
receive, via the touch-sensitive display screen, information pertaining to a sliding action performed by a user;
determine whether the sliding action is a designated sliding action;
display a classification options zone containing a plurality of classification labels in the event that the sliding action is the designated sliding action;
select a classification label from among the plurality of classification labels;
sequentially change the classification label that is selected from among the plurality of classification labels based on the designated sliding action; and
to switch a current classified webpage to a classified webpage corresponding to the selected classification label in the event that contact of the sliding action with the touch-sensitive display screen has stopped; and
a memory coupled to the at least one processor and configured to provide the at least one processor with instructions.

9. The device as described in claim 8, where the display of the classification options zone comprises:
display the classification options zone containing the plurality of classification labels at the top of the touch-sensitive display screen in the event that the sliding action is a downward sliding action;
display the classification options zone containing the plurality of classification labels at the bottom of the touch-sensitive display screen in the event that the sliding action is an upward sliding action;
display the classification options zone containing the plurality of classification labels on the left side of the touch-sensitive display screen in the event that the sliding action is a rightward sliding action; and
display the classification options zone containing the plurality of classification labels on the right side of the touch-sensitive display screen in the event that the sliding action is a leftward sliding action.

10. The device as described in claim 8, wherein the display of the classification options zone comprises sequentially change the classification label that is selected from the classification options zone which was triggered for display in accordance with a set speed and a set direction.

11. The device as described in claim 8, further comprising:
determine a current sliding direction of the sliding action after the display of the classification options zone containing the plurality of classification labels; and
sequentially change the classification label that is selected from the classification options zone which was selected for display in accordance with a direction corresponding to the current sliding direction of the sliding action.

12. The device as described in claim 8, wherein the sliding action occurs in a region on the touch-sensitive display screen different from the classification options zone.

13. A computer program product for classified webpage switching, the computer program product being embodied in a non-transitory computer readable storage medium and comprising computer instructions for:
receiving, via a touch-sensitive display screen, information pertaining to a sliding action performed by a user;
determining whether the sliding action is a designated sliding action;
displaying a classification options zone containing a plurality of classification labels in the event that the sliding action is the designated sliding action;
selecting a classification label from among the plurality of classification labels;
sequentially changing the classification label that is selected from among the plurality of classification labels based on the sliding action; and
switching a current classified webpage to a classified webpage corresponding to the selected classification label in the event that contact of the sliding action with the touch-sensitive display screen has stopped.

14. The computer program product as described in claim 13, wherein the displaying of the classification options zone containing the plurality of classification labels, in the event that the sliding action is the designated sliding action, comprises:
displaying the classification options zone containing the plurality of classification labels at the top of the touch-sensitive display screen in the event that the sliding action is a downward sliding action.

15. The computer program product as described in claim 13, wherein the displaying of the classification options zone containing the plurality of classification labels, in the event that the sliding action is a designated sliding action, comprises one of the following steps:
displaying the classification options zone containing the plurality of classification labels at the bottom of the touch-sensitive display screen in the event that the sliding action is an upward sliding action;
displaying the classification options zone containing the plurality of classification labels on the left side of the touch-sensitive display screen in the event that the sliding action is a rightward sliding action; and
displaying the classification options zone containing the plurality of classification labels on the right side of the touch-sensitive display screen in the event that the sliding action is a is leftward sliding action.

16. The computer program product as described in claim 13, wherein the displaying of the classification options zone containing the plurality of classification labels, in the event that the sliding action is a designated sliding action, comprises:
the classification label that is selected from the classification options zone which was triggered for display undergoes sequential change in accordance with a set speed and a set direction.

17. The computer program product as described in claim 13, wherein the displaying of the classification options zone containing the plurality of classification labels, in the event that the sliding action is the designated sliding action, further comprises:
determining a current sliding direction of the sliding action,
wherein the sequentially changing of the classification label that is selected from among the plurality of classification labels occurs in accordance with a direction corresponding to the current sliding direction of the sliding action.

18. The computer program product as described in claim 17, wherein the displaying of the classification options zone containing the plurality of classification labels, in the event that the sliding action is the designated sliding action, further comprises:
determining a current sliding speed of the sliding action,
wherein the sequentially changing of the classification label that is selected from among the plurality of classification labels occurs in accordance with a speed corresponding to the current sliding speed of the sliding action and the direction corresponding to the current sliding direction of the sliding action.

19. The computer program product as described in claim 13, wherein the sliding action to occurs in a region on the touch-sensitive display screen different from the classification options zone.
